(19) United States
(12) Patent Application Publication
(10) Pub. No.: US 2005/0189789 A1
(43) Pub. Date: Sep. 1, 2005

(54) Energy absorbing impact deflector for use in vehicle doors

(76) Inventor: Glen D. Schmidt, New Baltimore, MI (US)

Correspondence Address: David J. Simonelli, Esq.;Clark Hill PLC, Suite 3500, 500 Woodward Ave., Detroit, MI, 48226-3435, US

(21) Appl. No.: 10/790,352

(22) Filed: Mar. 1, 2004

(51) Int. Cl. B62D 25/14

(52) U.S. Cl. 296/187.12

(57) ABSTRACT

A door assembly includes a door frame having an outer door panel. A trim pad, having an inboard surface, is fixedly secured to the door frame. The trim pad defines an interior space between the trim pad and the outer door panel. An intermediate barrier is fixedly secured to the door frame between the outer door panel and the trim pad. The intermediate barrier has at least one side impact portion and a water-impervious outboard surface defining a periphery thereabout.

### BACKGROUND ART

1. Field of the Invention

The present invention relates generally to both impact resistant barriers for incorporation into a vehicle door, as well as water, dust and sound barrier applications. More particularly, the present invention is a three dimensional molded and structural (component supporting) article incorporated between a vehicle door and covering trim pad, and which provided the combined aspects of environmental (water, dust and sound) protection as well as side impact deflection.

2. Description of the Related Art

The prior art is well documented with examples of door mounted and energy impacting modules and the like. A first example of this is illustrated in U.S. Pat. No. 5,308,138, issued to Hlavaty, and which teaches a support frame cartridge mounted between inner and outer door panels and including push-on mounting studs for mounting a pair of energy-absorbing pads. Notches provided in the belt line cross member better utilize the energy-absorbing pads, thus increasing the dynamic side impact protection to an occupant of the vehicle. The energy absorbing members are further disclosed as being constructed of sheets or panels of closed-cell polystyrene foam.

U.S. Pat. No. 6,197,403, issued to Brown, teaches an integral sound absorber and water deflector door panel having a first polymeric and water impervious layer and a second polymeric foam layer. An outer face of the second polymeric layer contacts a portion of the exteriorly oriented face of the passenger compartment door. The thickness of the first polymeric layer of the integral door panel is further uniform through the part, while the thickness of the second polymeric layer contacts a portion of the exteriorly oriented face of the passenger compartment door. The thickness of the first polymeric layer of the integral door panel is further uniform through the part, while the thickness of the second polymeric layer varies positionally to conform to the dimensional requirements of the surrounding door assembly and specific vibrational and noise abatement requirements of the given door assembly and associated automotive vehicle.

U.S. Pat. No. 6,233,875, issued to Carlo, teaches a sealed module for a vehicle door including a rigid peripheral part and a plate connected on its periphery and in a sealed manner to the rigid peripheral part and filling the area defined by the latter. The plate is further disclosed as being composed of an inexpensive material which reduces the cost of the module while maintaining its mechanical properties on the peripheral part. A device, such as a window winding mechanism, is fixed to the rigid part.

Additional references of note include U.S. Pat. No. 6,062,624, issued to Crabtree, which teaches a sealing acoustical baffle and method and by which a sealing material fills a cavity of a pillar or other body member of a vehicle. Salmonowicz et al. U.S. Pat. No. 5,762,394 teaches a vehicle door with a structural plastic inner panel. Bradac U.S. Pat. No. 5,482,343 teaches a vehicle door and water deflector including a plastic water deflector sheet positioned between the trim panel and the inner door panel.

Finally, U.S. Pat. No. 5,456,513, issued to Schmidt, discloses a sound, water and dust barrier having a laminated body with a central layer composed of a filled plastic which provides sound dampening characteristics to the water barrier. Additional outer layers of an unfilled plastic sandwich the central layer. Vacuum formed speaker recesses or like contoured shapes may be provided for accommodating suitable components and flexible clip pockets are sealingly attached about openings in the body to allow the water barrier to be clipped to the inner and outer door panels of the vehicle door. An adhesive and release agent may be applied on the opposing outer layers and, in the preferred application, the center and outer layers are coextruded together.

### SUMMARY OF THE INVENTION

The invention is an intermediate barrier incorporated between a vehicle door and covering trim pad, and which provides the combined aspects of environmental (water, dust and sound) protection as well as side impact deflection. In particular, the invention combines the technology associated with side impact blocks, into an integral and three dimensional construction which is installed into a vehicle trim pad and prior to subsequent installation of the trim pad into the inner facing metal of the vehicle door. A furthering advantage of pre-installing the molded and structural component into the trim pad is to facilitate installation of additional sound blocking and absorbing materials, wiring harnesses, wire harness attachment devices, speakers, speaker attachment devices and other seals and components, thus reducing the number of parts entering the assembly plants.

The intermediate barrier exhibits a specified length, width and thickness and is constructed of a suitable energy absorbing structural foam, such as possibly including a urethane, a polyolefin, or an impact resistant styrene. In the preferred application, the intermediate barrier is constructed in a suitable molding operation and to include both the provision of varying projections and recesses on one or both faces thereof, at least one aperture formed therethrough, and as well as the configuration of impact absorbing portions defined at selected locations.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is an exploded perspective view of the combination energy absorption and environmental insulating barrier integrated between the vehicle door and associated trim pad and according to a preferred embodiment of the invention;

FIG. 2 is further perspective view, in partial cutaway fashion, of an inner facing side of the invention and over which is installed the vehicle trim pad and

FIG. 3 is a 180° rotated perspective view of the invention and illustrating an opposite and outer facing side which is nestingly received the associated and inner facing side of the vehicle door.

### DETAILED DESCRIPTION OF THE PREFERRED EMBODIMENT

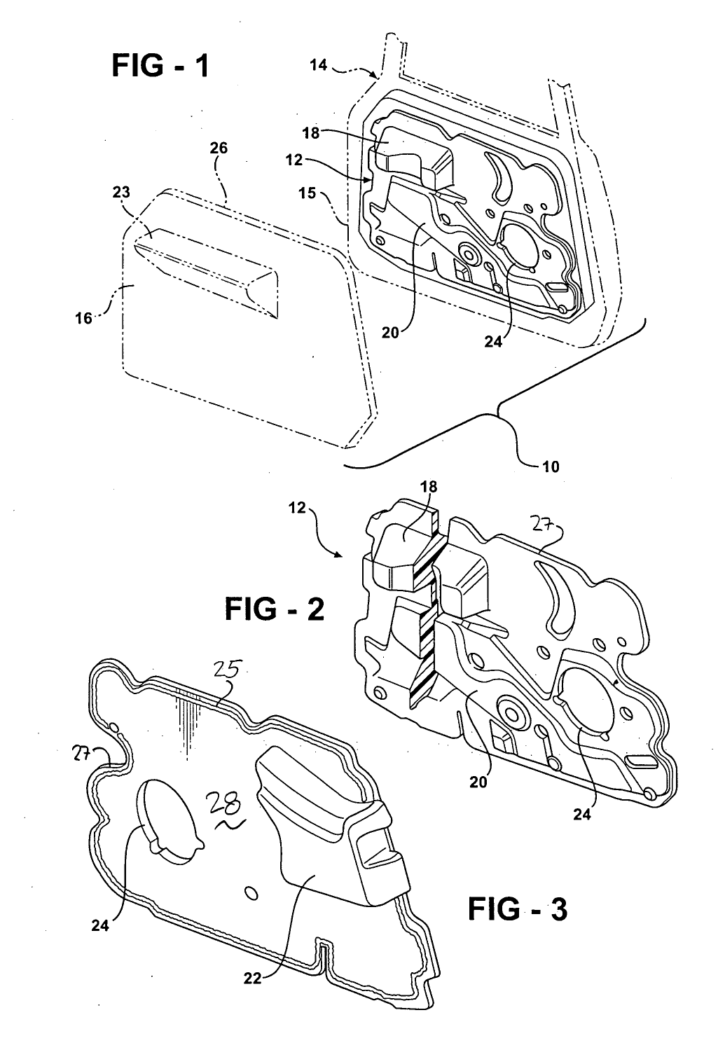

Referring to FIG. 1 a vehicle door assembly is illustrated at 10. An intermediate barrier 12 is secured to a vehicle door, generally shown at 14, between a door frame 15 and an associated and overlaying trim pad 16. The intermediate barrier 12 provides environmental (water, dust and sound) protection and side impact deflection. In particular, the intermediate barrier 12 combines the technology of current environmental door barriers, with the technology associated with side impact blocks, into an integral and three dimensional construction, which is installed into the vehicle trim pad 16 and prior to installation of the trim pad 16 into the inner facing metal frame 15 of the vehicle door 14.

Referring to FIGS. 1 and 2 the intermediate barrier 12 is provided as a three dimensional structural component exhibiting a specified length, width and thickness corresponding generally to the outline of the door frame 15. The intermediate barrier 12 is constructed of a suitable energy absorbing structural foam such as a urethane, a polyolefin, or an impact resistant styrene. In the preferred application, the intermediate barrier 12 is constructed in a suitable molding operation. The intermediate barrier 12 includes both the provision of varying projections and recesses, such as a first protrusion 18 for armrest portion and a second protrusion 20 where a structural beam will abut.

Referring to the rotated view in FIG. 3, an additional projection includes a reinforcing portion 22 associated with a reverse facing side 26 of the first protrusion 18. The reinforcing portion 22 is nestingly received within the inner facing configuration of the vehicle door 14. In addition, an aperture is shown having an inner annular surface 24. The aperture 24 is designed to be fully closed by a device, e.g., a stress speaker, upon installation in the vehicle door 14. Therefore, the intermediate barrier 12 may incorporate other devices to complete its seal.

The intermediate barrier 12 is sealed against the door frame 15. To create the seal, a bead of soft foam or an adhesive 25 is deposited on a periphery 27 of the outboard surface 28 of the intermediate barrier 12. The bead of material 25 is a soft foam or an adhesive. When the intermediate barrier 12 is pressed against the door frame 15, a seal is created. The intermediate barrier 12 is moisture impervious and prevents moisture from moving past it, the seal and any components that may fill hole 24, thus adequately protecting the trim pad 16 from any moisture that may enter the door 14.

It is also contemplated that additional components, such as previously recited and again including one or more of an acoustic blocking material, acoustic absorbing material, gaskets, seals, clips, brackets, wiring harnesses, wire harness attachment devices, speakers, speaker attachment devices, motors, handles, lock rods, air bags, and seals are capable of being installed into the intermediate barrier 12 either before or during the attachments of the trim pad 16 to the door frame 14. It has been found that the structural integrity inherently derived from the intermediate barrier 12 makes possible the affixation or incorporation of the various components and accessories, this not previously having been possible with earlier and less robust barrier designs. In this manner, the number of parts needed for assembly is reduced.

In operation, the intermediate barrier 12 replaces two components that are currently used, namely, a side impact block and a water shield. The seal material 25 is applied to the periphery 27 of the outboard surface 28 of the intermediate barrier 12. It is then secured to the door frame 15 pressing the seal material 25 therebetween. This creates an intermediate seal between the portion of the door 14 facing the outboard surface 28 of the intermediate barrier, and the remaining portion of the door 14. Components are added with the appropriate seals into the hole 24 provided by the intermediate barrier 12 to complete the seal and to allow the trim pad 16 to be protected from moisture collected by the door 12.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A door assembly comprising:
a door frame having an outer door panel;
a trim pad having an inboard surface, said trim pad fixedly secured to said door frame and defining an interior space between said trim pad and said outer door panel; and
an intermediate barrier fixedly secured to said door frame between said outer door panel and said trim pad, said intermediate barrier having a side impact portion and a water-impervious outboard surface defining a periphery thereabout.

2. A door assembly as set forth in claim 1 including a seal extending about said periphery of said water-impervious outboard surface of said intermediate barrier to create a seal preventing water that is collected by said door assembly from traveling past said intermediate barrier to said trim pad.

3. An intermediate barrier article fixedly securable within a door assembly, said intermediate barrier article comprising:
a panel of water-impervious material to prevent water collected by the door assembly from moving therepast; and
a side impact portion disposed within said panel of water-impervious material to aid in the absorption of energy received from a side impact.

4. An intermediate barrier article as set forth in claim 4 wherein said energy absorbing foam includes a urethane and an impact resistant styrene.

5. An intermediate barrier article as set forth in claim 5 wherein components of the door assembly are fixedly secured thereto.

6. An intermediate barrier article as set forth in claim 6 including an aperture allowing one of the components of the door assembly to extend therethrough.
